(19) United States
(12) Patent Application Publication
(10) Pub. No.: US 2015/0361908 A1
(43) Pub. Date: Dec. 17, 2015

(54) SHIP

(71) Applicant: YANMAR CO., LTD., Osaka-shi, Osaka (JP)

(72) Inventor: Gou ASAI, Osaka-shi, Osaka (JP)

(21) Appl. No.: 14/761,184

(22) PCT Filed: Jan. 14, 2014
(86) PCT No.: PCT/JP2014/050480

§ 371 Date: Jul. 15, 2015

(30) Foreign Application Priority Data
Jan. 15, 2013 (JP) 2013-004947

(51) Int. Cl. F02D 41/04; B63H 5/00; B63H 23/30

(52) U.S. Cl. CPC F02D 41/042; B63H 23/30; B63H 5/00

(57) ABSTRACT

The purpose is to provide a ship such that the pressure in a common rail of a fuel injection device for a stopped engine is prevented in advance from increasing due to a rotating force generated by a stream of water. Provided is a ship with multiple engines controlled by means of a ship navigation control device, said ship being configured such that a single or multiple propellers for propulsion are connected to the multiple engines, and such that the ship navigation control device determines, when the sea speed of the ship is equal to or greater than a predetermined speed when engine(s) among the multiple engines are stopped, that there is a possibility of the output shafts of the stopped engines being rotated by a motive force applied to the propellers for propulsion by a stream of water.

### TECHNICAL FIELD

The present invention relates to a ship. In detail, the present invention relates to a ship having pressure suppression function of a fuel injection device.

### BACKGROUND ART

Conventionally, a ship is known in which power is transmitted from a motor (engine) arranged inside or outside a hull to a plurality of propulsion devices arranged outside the hull. The propulsion devices rotate propellers so as to propel the hull.

In the ship having the plurality of the propulsion devices, when rotation of a part of the propellers is stopped by stop of the engine, water flow acts on the propellers so as to generate rotation power. When the rotation power reaches a fixed value, a drive shaft (output shaft) of the engine is rotated by the rotation power. As a result, a fuel injection pump connected interlockingly to the output shaft of the engine is driven and involuntary supply of fuel to a fuel injection device is caused. For preventing the situation, there is a ship in which interlock of the propeller and the output shaft of the engine is canceled when rotation of the output shaft of the engine by the rotation power from the water flow is detected. For example, a ship described in the Patent Literature 1 is so.

However, in the ship described in the Patent Literature 1, when the rotation of the output shaft of the engine by the rotation power from the water flow is detected, the interlock of the propeller and the output shaft of the engine is canceled. Namely, there is a problem that until canceling the interlock of the propeller and the output shaft of the engine, the fuel is supplied and fuel pressure in the fuel injection device is increased.

### PRIOR ART REFERENCE

### Patent Literature

Patent Literature 1: the Japanese Patent Laid Open Gazette 2010-255848

### DISCLOSURE OF INVENTION

### Problems to be Solved by the Invention

The present invention is provided for solving the above problem, and the purpose of the present invention is to provide a ship in which increase of pressure in a fuel injection device of a stopped engine by rotation power from water flow can be prevented beforehand.

### Means for Solving the Problems

The problems to be solved by the present invention have been described above, and subsequently, the means of solving the problems will be described below.

According to the present invention, in a ship in which a plurality of engines are controlled by a ship navigation control device, one or more propellers are connected interlockingly to the plurality of the engines, and in the state in which one or more of the plurality of the engines are stopped, when a speed of water flow with respect to the ship is not less than a predetermined speed, the ship navigation control device judges that there is a possibility of an output shaft of the stopped engine being rotated by power applied from the water flow to the propeller.

According to the present invention, when the possibility of the output shaft of the stopped engine being rotated by the power applied from the water flow to the propeller is judged to exist, the ship navigation control device turns on a control device of the stopped engine.

According to the present invention, a fuel regulating valve is provided in a suction port of a fuel supply pump in the engine, the output shaft and the propeller are connected interlockingly via a clutch transmitting rotation power from the engine to the propeller, and when the possibility of the output shaft of the stopped engine being rotated by the power applied from the water flow to the propeller is judged to exist, the ship navigation control device closes the fuel regulating valve of the stopped engine and shifts the clutch to a neutral position.

According to the present invention, a pressure relief valve is provided in a fuel injection device in the engine, and when the possibility of the output shaft of the stopped engine being rotated by the power applied from the water flow to the propeller is judged to exist, the pressure relief valve of the stopped engine is opened.

According to the present invention, a closing valve is provided in a fuel pipe, and in the state in which one or more of the plurality of the engines are stopped, when the speed of the water flow with respect to the ship is not less than the predetermined speed, the ship navigation control device judges that there is a possibility of the output shaft of the stopped engine being rotated by power applied from the water flow to the propeller and closes the closing valve.

### Effect of the Invention

The present invention brings the following effects.

According to the present invention, possibility of the output shaft of the stopped engine being rotated is judged in consideration with the water flow. Accordingly, increase of the pressure of the fuel injection device of the stopped engine by rotation power of the water flow can be prevented beforehand.

According to the present invention, attached apparatuses of the stopped engine can be controlled. Accordingly, increase of the pressure of the fuel injection device of the stopped engine by the rotation power of the water flow can be prevented beforehand.

According to the present invention, fuel supply by the fuel supply pump is suppressed. Power transmission from the propeller is suppressed. Accordingly, increase of the pressure of the fuel injection device of the stopped engine by the rotation power of the water flow can be prevented beforehand.

According to the present invention, increase of the pressure of the fuel injection device is suppressed. Accordingly, increase of the pressure of the fuel injection device of the stopped engine by the rotation power of the water flow can be prevented beforehand.

According to the present invention, fuel is not supplied to the fuel supply pump. Accordingly, increase of the pressure of the fuel injection device of the stopped engine by rotation power of the water flow can be prevented beforehand.

### BRIEF DESCRIPTION OF DRAWINGS

FIG. 1 is a drawing of an entire outline of a ship according to the present invention.

FIG. 2 is a schematic drawing of an engine and an outdrive device of the ship according to the present invention.

FIG. 3 is a drawing of a common rail type fuel injection device of the ship according to the present invention.

FIG. 4 is a diagram of control flow of selection of pressure suppress control of a first embodiment of the ship according to the present invention.

FIG. 5 is a diagram of flow of pressure suppress control A of the first embodiment of the ship according to the present invention.

FIG. 6 is a diagram of flow of pressure suppress control A of a second embodiment of the ship according to the present invention.

FIG. 7(a) is a schematic drawing of a state in which pitch of propeller of a third embodiment of the ship according to the present invention is a normal angle. FIG. 7(b) is a schematic drawing of a state in which pitch of propeller of the third embodiment of the ship according to the present invention is at feathering state.

FIG. 8 is a diagram of flow of pressure suppress control A of the third embodiment of the ship according to the present invention.

### DETAILED DESCRIPTION OF THE INVENTION

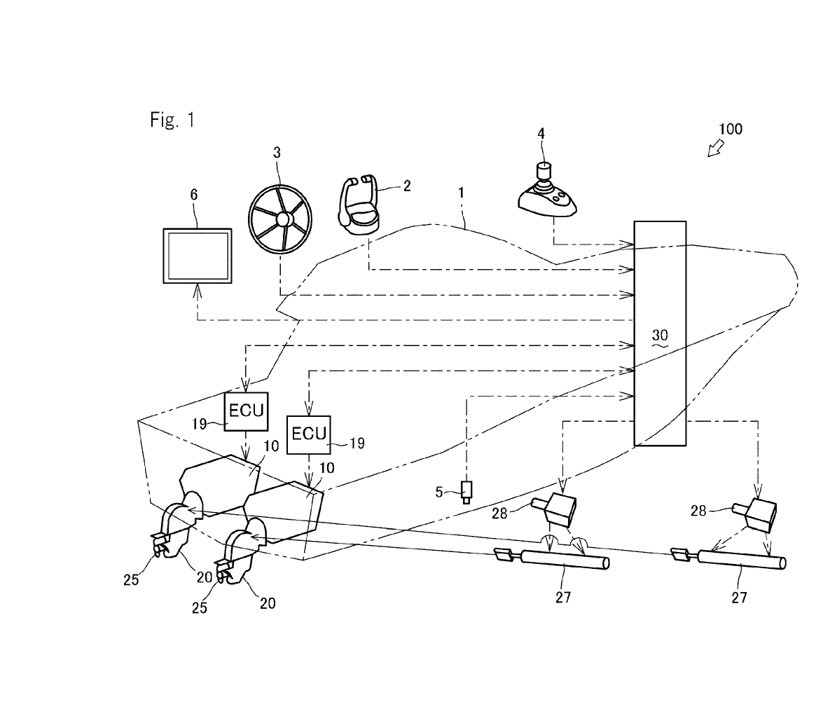

Firstly, an entire outline and a configuration of a ship 100 which is a first embodiment according to the present invention are explained referring to FIGS. 1 to 3. The ship 100 in FIG. 1 is a so-called biaxial propulsion ship. However, number of propulsion axes is not limited thereto and a plurality of axes may be provided.

As shown in FIG. 1, in the ship 100, a drive state of engines 10 is controlled corresponding to operation of an acceleration lever 2, and the ship 100 is propelled by propellers 25 of outdrive devices 20. A route of the ship 100 is changed by changing a direction of the outdrive device 20 by a steering wheel 3 and a joystick lever 4. In the ship 100, a hull 1 has the two engines 10, the two outdrive devices 20, and a ship navigation control device 30. Though the ship 100 has the two engines 10 in this embodiment, the present invention is not limited thereto.

The hull 1 of the ship 100 has the steering wheel 3 and the joystick lever 4 for controlling the outdrive devices 20, and an electromagnetic log 5 detecting a log speed of the ship 100. In the electromagnetic log 5, a coil generating a magnetic field is arranged in a bottom of the ship, and a voltage E of electromotive power induced by fluid passing through the coil can be detected. The detected voltage E of the electromotive power is used in the ship navigation control device 30 discussed below for calculating velocity V of water flow with respect to the ship 100 (hereinafter, simply referred to as “log speed V”). Furthermore, in the hull 1, near the steering wheel 3 and the like, a monitor 6 displaying operation state of these members, the log speed and the like is arranged. Though the log speed V is calculated by the electromagnetic log 5 in this embodiment, the present invention is not limited thereto.

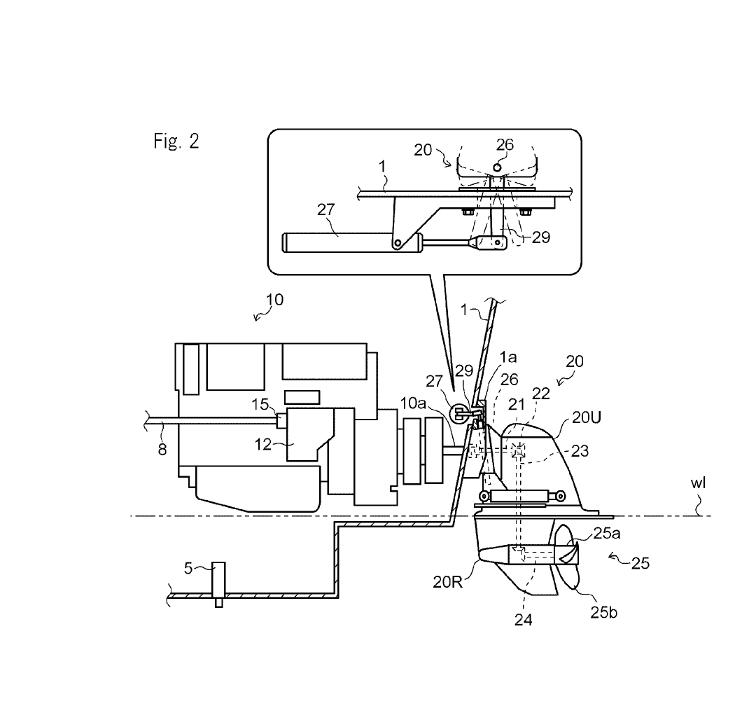

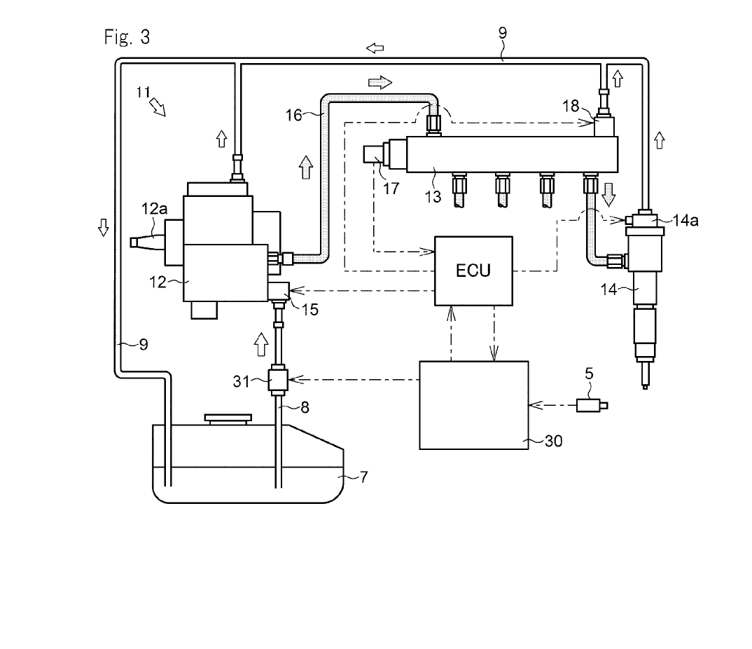

As shown in FIGS. 2 and 3, the two engines 10 mix fuel supplied from a fuel injection valve 14a with air in a plurality of cylinders (not shown) and burn it so as to drive rotatively output shafts 10a. The output shafts 10a of the engines 10 are connected interlockingly to input shafts of the outdrive devices 20 discussed below. Each of the engines 10 has a fuel injection device 11 of a common rail 13-type (hereinafter, simply referred to as “fuel injection device 11”) shown in FIG. 3 and an ECU 19 which is an engine control device. The fuel injection device 11 is configured by a fuel supply pump 12, the common rail 13 and a plurality of fuel injection nozzles 14.

The fuel supply pump 12 supplies fuel to the common rail 13. An input shaft 12a of the fuel supply pump 12 is connected interlockingly to the output shaft 10a of the engine 10. Namely, the fuel supply pump 12 can be operated by rotational power from the output shaft 10a of the engine 10. In a suction port of the fuel supply pump 12, a fuel regulating valve 15 is provided. The fuel supply pump 12 is connected via the fuel regulating valve 15 to a fuel pipe 8 from a fuel tank 7 arranged in the hull 1. A discharge port of the fuel supply pump 12 is connected via a fuel supply pipe 16 having high pressure resistance to the common rail 13. Accordingly, the fuel supply pump 12 can suck fuel in the fuel tank 7 via the fuel pipe 8 and supply the fuel via the fuel supply pipe 16 to the common rail 13 (see colored arrows in FIG. 3).

The fuel regulating valve 15 of the fuel supply pump 12 is configured by an electromagnetic flow control valve. An opening degree of the fuel regulating valve 15 can be changed based on a signal from the ECU 19 discussed below. Accordingly, the fuel regulating valve 15 can interrupt a flow of fuel sucked by the fuel supply pump 12 from the fuel tank 7. Namely, the fuel supply pump 12 can stop supply of fuel to the common rail 13 by the fuel regulating valve 15. Though the fuel regulating valve 15 is configured by the electromagnetic flow control valve in this embodiment, any member which can change a flow rate of fuel may be used.

The common rail 13 stores fuel at high pressure. The common rail 13 is connected via the fuel supply pipe 16 to the discharge port of the fuel supply pump 12. Furthermore, the common rail 13 is connected to the plurality of the fuel injection nozzles 14. Accordingly, the common rail 13 can store fuel supplied from the fuel supply pump 12 and supply the fuel to the plurality of the fuel injection nozzles 14.

In the common rail 13, a pressure sensor 17 and a pressure relief valve 18 are provided. The pressure sensor 17 detects a pressure P of fuel in the common rail 13. The pressure relief valve 18 releases pressure in the common rail 13. The pressure relief valve 18 is configured by an electromagnetic valve. The common rail 13 is connected via the pressure relief valve 18 to a recovery pipe 9 which is communicated with the fuel tank 7. The pressure relief valve 18 can be opened and closed based on a signal from the ECU 19 discussed below. Accordingly, the pressure relief valve 18 can discharge fuel in the common rail 13 to the fuel tank 7. Though the pressure relief valve 18 is configured by the electromagnetic valve in this embodiment, any member which can which can release the fuel in the common rail 13 to the outside may be used.

The fuel injection nozzle 14 injects fuel to the cylinders (not shown) of the engine 10. The fuel injection nozzle 14 has the fuel injection valve 14a configured by an electromagnetic valve. The fuel injection nozzle 14 is connected the fuel injection valve 14a to the common rail 13. By opening and closing the fuel injection valve 14a based on a signal from the ECU 19 discussed below, the fuel injection nozzle 14 can opens and closes a fuel passage in the fuel injection nozzle 14. Accordingly, fuel at high pressure in the common rail 13 is injected into the cylinders when the fuel injection valve 14a is opened.

The ECU 19 which is the engine control device controls the engine 10. Various programs are stored in the ECU 19 so as to control the engine 10. The ECU 19 is provided for each of the engines 10. The ECU 19 may be configured by connecting a CPU, a ROM, a RAM, a HDD and the like with a bus, or may alternatively be a one-chip LSI or the like.

The ECU 19 is connected to the fuel regulating valve 15 of the fuel supply pump 12 and can control the opening degree of the fuel regulating valve 15.

The ECU 19 is connected to the pressure relief valve 18 of the common rail 13 and can control opening and closing of the pressure relief valve 18.

The ECU 19 is connected to the fuel injection valve 14a and can control opening and closing of the fuel injection valve 14a.

The ECU 19 is connected to the pressure sensor 17 and can obtain the pressure P of fuel in the common rail 13 detected by the pressure sensor 17.

As shown in FIG. 2, the outdrive device 20 generates propulsion power by rotating the propeller 25. The outdrive device 20 is configured mainly by an input shaft 21, a switching clutch 22, a drive shaft 23, an output shaft 24 and the propeller 25. The one outdrive device 20 is connected interlockingly to the one engine 10. The number of the outdrive device 20 with respect to the engine 10 is not limited to that of this embodiment. A drive device is not limited to the outdrive device 20 of this embodiment and may alternatively be a device in which a propeller is driven directly or indirectly by the engine or a device of POD type.

The input shaft 21 transmits rotational power of the engine 10 to the switching clutch 22. One of ends of the input shaft 21 is connected to a universal joint attached to the output shaft 10a of the engine 10, and the other end thereof is connected to the switching clutch 22 arranged inside an upper housing 20U.

The switching clutch 22 can switch the rotational power of the engine 10, which is transmitted via the input shaft 21 and the like, to forward or reverse direction. The switching clutch 22 has a forward bevel gear and a reverse bevel gear connected to an inner drum having disc plates. The switching clutch 22 transmits the power by pushing a pressure plate of an outer drum connected to the input shaft 21 to one of the disc plates. The switching clutch 22 does not transmit the rotational power of the engine 10 to the propeller 25 by shifting the pressure plate to a neutral position at which the pressure plate is not pushed to neither of the disc plates.

The drive shaft 23 transmits the rotational power of the engine 10, which is transmitted via the switching clutch 22 and the like, to the output shaft 24. A bevel gear provided at one of ends of the drive shaft 23 is meshed with the forward bevel gear and the reverse bevel gear provided in the switching clutch 22, and a bevel gear provided at the other end thereof is meshed with a bevel gear of the output shaft 24 arranged inside a lower housing 20R.

The output shaft 24 transmits the rotational power of the engine 10, which is transmitted via the drive shaft 23 and the like, to the propeller 25. The bevel gear provided at one of ends of the output shaft 24 is meshed with the bevel gear of the drive shaft 23 as the above, and the other end thereof is attached thereto with the propeller 25.

The propeller 25 generates propulsion power by rotation. The propeller 25 is driven by the rotational power of the engine 10 transmitted via the output shaft 24 and the like, and a plurality of blades 25b arranged around a rotation shaft 25a paddle water so as to generate propulsion power.

The outdrive device 20 is supported by a gimbal housing 1a attached to a stern board (transom board) of the hull 1. Concretely, the outdrive device 20 is supported by the gimbal housing 1a so that a gimbal ring 26 which is a rotation fulcrum of the outdrive device 20 is substantially perpendicular to a waterline w1.

A steering arm 29 extended into the hull 1 is attached to an upper end of the gimbal ring 26. The steering arm 29 rotates the outdrive device 20 around the gimbal ring 26. The steering arm 29 is driven by a hydraulic actuator 27 interlocked with operation of the steering wheel 3 and the joystick lever 4. The hydraulic actuator 27 is driven by an electromagnetic proportional control valve 28 (see FIG. 1) which switches a flow direction of pressure oil corresponding to the operation of the steering wheel 3 and the joystick lever 4.

As shown in FIG. 1, the ship navigation control device 30 controls the engine 10 and the outdrive device 20 based on detection signals from the acceleration lever 2, the steering wheel 3, the joystick lever 4 and the like. The ship navigation control device 30 may be configured to be able to perform so-called automatic navigation that a route is calculated from a position of the ship and a set destination based on information from a global positioning system (GPS) and steering is performed automatically.

In the ship navigation control device 30, various programs and data for controlling the engine 10 and the outdrive device 20 are stored. The ship navigation control device 30 may be configured by connecting a CPU, a ROM, a RAM, a HDD and the like with a bus, or may alternatively be a one-chip LSI or the like.

The ship navigation control device 30 is connected to the acceleration lever 2, the steering wheel 3, the joystick lever 4 and the like and can obtain control signals from the acceleration lever 2, the steering wheel 3, the joystick lever 4 and the like.

The ship navigation control device 30 is connected to the electromagnetic proportional control valve 28 of each of the outdrive devices 20 and can control the electromagnetic proportional control valve 28 based on the control signals from the acceleration lever 2, the steering wheel 3, the joystick lever 4 and the like.

The ship navigation control device 30 is connected to the electromagnetic log 5 and can obtain the voltage E of the electromotive power detected by the electromagnetic log 5.

The ship navigation control device 30 can calculate the log speed of the ship 100 based on the obtained voltage E of the electromotive power.

The ship navigation control device 30 is connected to the ECU 19 of each of the engines 10 and can obtain drive state of the engines 10 and the pressure P of the common rail 13 and various signals obtained by the ECU 19.

The ship navigation control device 30 can transmit a signal for turning on and off the engines 10 (the ECU 19) and signals for controlling the fuel regulating valve 15 of the fuel supply pump 12, the pressure relief valve 18 of the common rail 13 and various kinds of equipment of the engines 10 to the ECU 19.

The ship navigation control device 30 is connected to the monitor 6 and can display operation state of the steering wheel 3, the joystick lever 4 and the like, state of the engines 10 based on various signals from the ECU 19, the calculated log speed of the ship 100, and the like on the monitor 6.

A control mode of pressure suppression of the fuel injection device 11 of the stopped engine 10 in the ship 100 which is the first embodiment of the ship according to the present invention is explained.

In the case in which some of the engines 10 are stopped, when the log speed V excesses a predetermined speed Vt, the ship navigation control device 30 closes the fuel regulating valves 15 of the stopped engines 10. When the pressure P of the common rail 13 excesses a predetermined pressure Pv, the pressure relief valves 18 of the stopped engines 10 are opened.

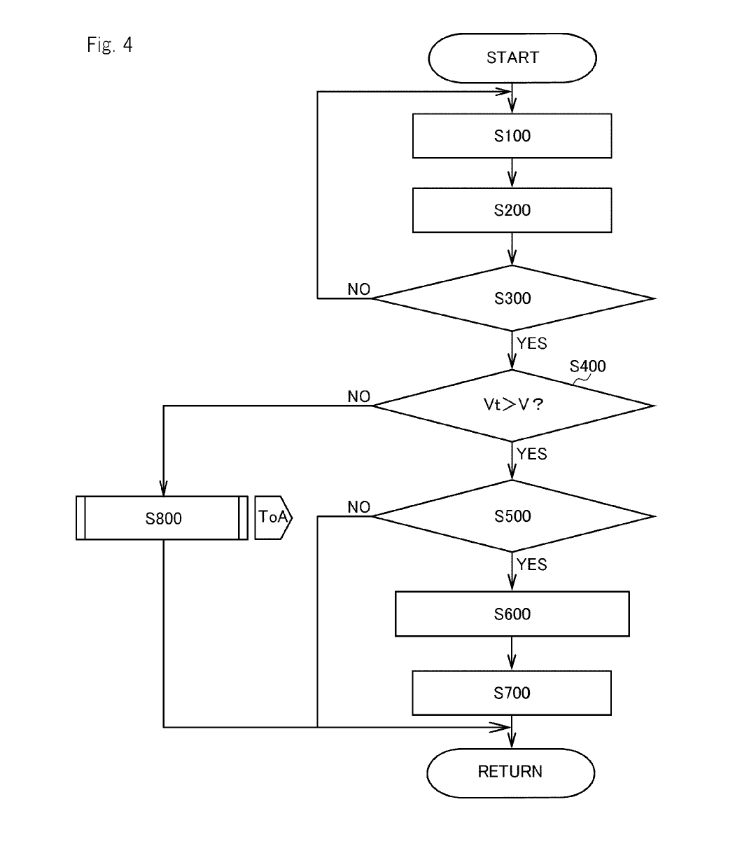

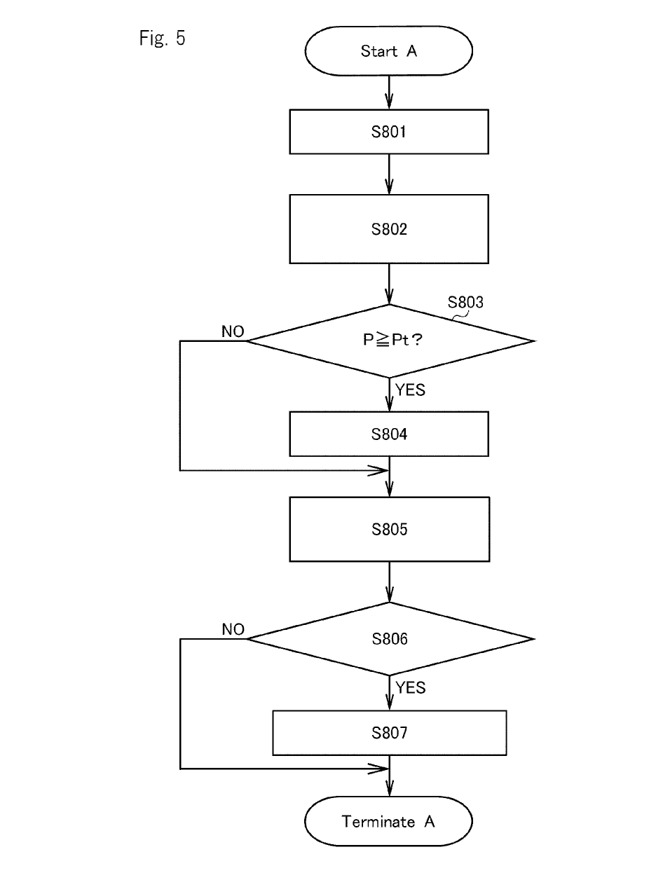

Next, the control mode of the ship navigation control device 30 is explained concretely referring to FIGS. 4 and 5.

As shown in FIG. 4, at a step S100, the ship navigation control device 30 obtains signals concerning starting state of the engines 10, the voltage E of the electromotive power detected by the electromagnetic log 5, and the pressure P of the common rail 13 detected by the pressure sensor 17 and shifts the control process to a step S200.

At the step S200, the ship navigation control device 30 calculates the log speed V of the ship 100 from the voltage E of the electromotive power detected by the electromagnetic log 5, and shifts the control process to a step S300.

At the step S300, the ship navigation control device 30 judges whether some of the engines 10 are stopped or not based on the obtained signals concerning the starting state of the engines 10.

As a result, when some of the engines 10 are judged to be stopped, the ship navigation control device 30 shifts the control process to a step S400.

On the other hand, when some of the engines 10 are judged not to be stopped, the ship navigation control device 30 shifts the control process to the step S100.

At the step S400, the ship navigation control device 30 judges whether the calculated log speed V is less than the predetermined speed Vt or not.

As a result, when the calculated log speed V is judged to be less than the predetermined speed Vt, the ship navigation control device 30 shifts the control process to a step S500.

On the other hand, when the calculated log speed V is judged not to be less than the predetermined speed Vt, the ship navigation control device 30 shifts the control process to a step S800.

At the step S500, the ship navigation control device 30 judges whether the stopped engine 10 (ECU 19) is turned on or not based on the obtained signals concerning the starting state of the engines 10.

As a result, when the stopped engine 10 (ECU 19) is judged to be turned on, the ship navigation control device 30 shifts the control process to a step S600.

On the other hand, when the stopped engine 10 (ECU 19) is judged not to be turned on, the ship navigation control device 30 shifts the control process to the step S100.

At the step S600, the ship navigation control device 30 sets the fuel regulating valve 15 of the stopped engine 10 to a starting opening degree, closes the pressure relief valve 18 and shifts the control process to a step S700.

At the step S700, the ship navigation control device 30 turns off the stopped engine 10 (ECU 19) and shifts the control process to the step S100.

At the step S800, the ship navigation control device 30 starts pressure suppression control A and shifts the control process to a step S801 (see FIG. 5). When the pressure suppression control A is terminated, the ship navigation control device 30 shifts the control process to the step S100.

As shown in FIG. 5, at the step S801 of the pressure suppression control A, the ship navigation control device 30 turns on the stopped engine 10 (ECU 19) and shifts the control process to a step S802.

At the step S802, the ship navigation control device 30 closes the fuel regulating valve 15 of the stopped engine 10, shifts the switching clutch 22 to the neutral position, and shifts the control process to a step S803.

At the step S803, the ship navigation control device 30 judges whether the pressure P of the common rail 13 obtained by the pressure sensor 17 of the stopped engine 10 is not less than the predetermined pressure Pv or not.

As a result, when the pressure P of the common rail 13 of the stopped engine 10 is judged to be not less than the predetermined pressure Pv, the ship navigation control device 30 shifts the control process to a step S804.

On the other hand, when the pressure P of the common rail 13 is judged to be less than the predetermined pressure Pv, the ship navigation control device 30 shifts the control process to a step S805.

At the step S804, the ship navigation control device 30 opens the pressure relief valve 18 of the stopped engine 10 and shifts the control process to the step S805.

At the step S805, the ship navigation control device 30 displays state of the fuel regulating valve 15 and the pressure relief valve 18 of the stopped engine 10 on the monitor 6, and shifts the control process to a step S806.

At the step S806, the ship navigation control device 30 judges whether a start signal of the stopped engine 10 is received or nor.

As a result, when the start signal of the stopped engine 10 is judged to be received, the ship navigation control device 30 shifts the control process to a step S807.

On the other hand, when the start signal of the stopped engine 10 is judged not to be received, the ship navigation control device 30 terminates the pressure suppression control A.

At the step S807, the ship navigation control device 30 sets the fuel regulating valve 15 of the stopped engine 10 to the starting opening degree, closes the pressure relief valve 18 and terminates the pressure suppression control A.

Though the pressure relief valve 18 is opened when the pressure P of the common rail 13 is not less than the predetermined pressure Pv in the pressure suppression control A, control in which the fuel regulating valve 15 is closed and the pressure relief valve 18 is opened regardless of the pressure P may alternatively be used.

As the above, in the ship 100 having pressure suppression function according to the present invention, the plurality of the engines 10 are controlled by the ship navigation control device 30, the one or more propellers 25 are connected interlockingly to each of the plurality of the engines 10, and in the state in which one or more of the plurality of the engines 10 are stopped, when the log speed V which is speed of water flow with respect to the ship 100 is not less than the predetermined speed Vt, the ship navigation control device 30 judges that there is a possibility of the output shaft 10a of the stopped engine 10 being rotated by power applied from the water flow to the propeller 25.

According to the configuration, possibility of the output shaft 10a of the stopped engine 10 being rotated is judged in consideration with the water flow. Accordingly, increase of the pressure P of the common rail 13 of the fuel injection device 11 of the stopped engine 10 by rotation power of the water flow can be prevented beforehand.

When the possibility of the output shaft 10a of the stopped engine 10 being rotated by the power applied from the water flow to the propeller 25 is judged to exist, the ship navigation control device 30 turns on the ECU 19 which is the control device of the stopped engine.

According to the configuration, attached apparatuses of the stopped engine 10 can be controlled. Accordingly, increase of the pressure P of the common rail 13 of the fuel injection device 11 of the stopped engine 10 by the rotation power of the water flow can be prevented beforehand.

In the engine 10, the fuel regulating valve 15 is provided in the suction port of the fuel supply pump 12, and the output shaft 10a and the propeller 25 are connected interlockingly via the switching clutch 22 transmitting the rotation power from the engine 10 to the propeller 25. When the possibility that the output shaft 10a of the stopped engine 10 is rotated by the power applied from the water flow to the propeller 25 is judged to exist, the ship navigation control device 30 closes the fuel regulating valve 15 of the stopped engine 10 and shifts the switching clutch 22 to the neutral position.

According to the configuration, fuel supply by the fuel supply pump 12 is suppressed. Power transmission from the propeller 25 is suppressed. Accordingly, increase of the pressure P of the common rail 13 of the fuel injection device 11 of the stopped engine 10 by the rotation power of the water flow can be prevented beforehand.

In the engine 10, the pressure relief valve 18 is provided in the fuel injection device 11. When the possibility of the output shaft 10a of the stopped engine 10 being rotated by the power applied from the water flow to the propeller 25 is judged to exist, the pressure relief valve 18 of the stopped engine 10 is opened.

According to the configuration, increase of the pressure P of the common rail 13 of the fuel injection device 11 is suppressed. Accordingly, increase of the pressure P of the common rail 13 of the fuel injection device 11 of the stopped engine 10 by the rotation power of the water flow can be prevented beforehand.

Next, the ship 100 which is a second embodiment of the ship according to the present invention is explained referring to FIGS. 3, 4 and 6. In below embodiment, concrete explanations of points similar to the embodiment explained above are omitted and points different from the above embodiment are explained mainly.

As shown in FIG. 3, in a middle part of the fuel pipe 8 connecting the fuel tank 7 arranged in the hull 1 to the fuel supply pump 12 of the engine 10, a closing valve 31 configured by an electromagnetic valve is provided. The closing valve 31 can intercept flow of fuel sucked by the fuel supply pump 12 from the fuel tank 7. Namely, the closing valve 31 can stop supply of fuel by the fuel supply pump 12 to the common rail 13. Though the closing valve 31 is configured by the electromagnetic valve in this embodiment, any member which can intercept flow of fuel may be used.

The ship navigation control device 30 is connected to the closing valve 31 of the fuel pipe 8 and can control opening and closing of the closing valve 31.

A control mode of pressure suppression of the fuel injection device 11 of the stopped engine 10 in the ship 100 which is the second embodiment of the ship according to the present invention is explained.

In the case in which some of the engines 10 are stopped, when the log speed V reaches the predetermined speed Vt, the ship navigation control device 30 closes the closing valves 31 of the stopped engines 10.

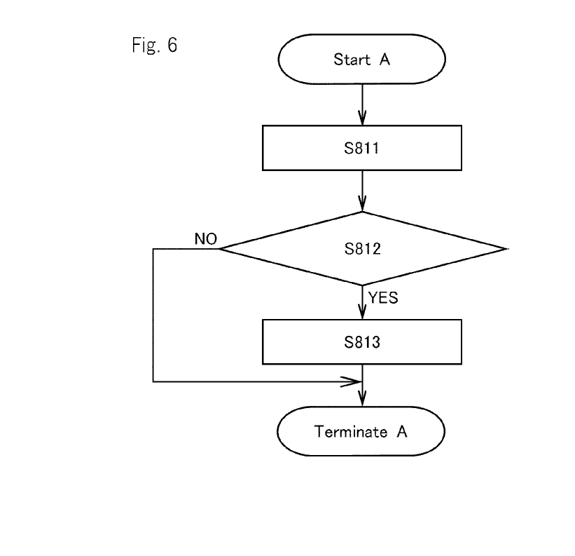

Next, the control mode of the ship navigation control device 30 is explained concretely referring to FIGS. 4 and 6.

As shown in FIG. 4, at the steps S100 to S700, the ship navigation control device 30 performs the control similar to the above control mode.

At a step S800, the ship navigation control device 30 starts the pressure suppression control A and shifts the control process to a step S811 (see FIG. 6). When the pressure suppression control A is terminated, the ship navigation control device 30 shifts the control process to the step S100.

As shown in FIG. 6, at the step S811 of the pressure suppression control A, the ship navigation control device 30 closes the closing valve 31 of the stopped engine 10 and shifts the control process to a step S812.

At a step S812, the ship navigation control device 30 judges whether a start signal of the stopped engine 10 is received or nor.

As a result, when the start signal of the stopped engine 10 is judged to be received, the ship navigation control device 30 shifts the control process to a step S813.

On the other hand, when the start signal of the stopped engine 10 is judged not to be received, the ship navigation control device 30 terminates the pressure suppression control A.

At a step S813, the ship navigation control device 30 opens the closing valve 31 of the stopped engine 10 and terminates the pressure suppression control A.

As the above, in the ship 100 having automatic calibration function according to the present invention, the plurality of the engines 10 are controlled by the ship navigation control device 30, the one or more propellers 25 are connected interlockingly to each of the plurality of the engines 10, the closing valve 31 is provided in the fuel pipe 8, and in the state in which one or more of the plurality of the engines 10 are stopped, when the log speed V which is speed of water flow with respect to the ship 100 is not less than the predetermined speed Vt, the ship navigation control device 30 judges that there is a possibility of the output shaft 10a of the stopped engine 10 being rotated by power applied from the water flow to the propeller 25 and closes the closing valve 31.

According to the configuration, fuel is not supplied to the fuel supply pump 12. Accordingly, increase of the pressure P of the common rail 13 of the fuel injection device 11 of the stopped engine 10 by rotation power of the water flow can be prevented beforehand.

Next, the ship 100 which is a third embodiment of the ship according to the present invention is explained referring to FIGS. 4, 7 and 8. In below embodiment, concrete explanations of points similar to the embodiment explained above are omitted and points different from the above embodiment are explained mainly.

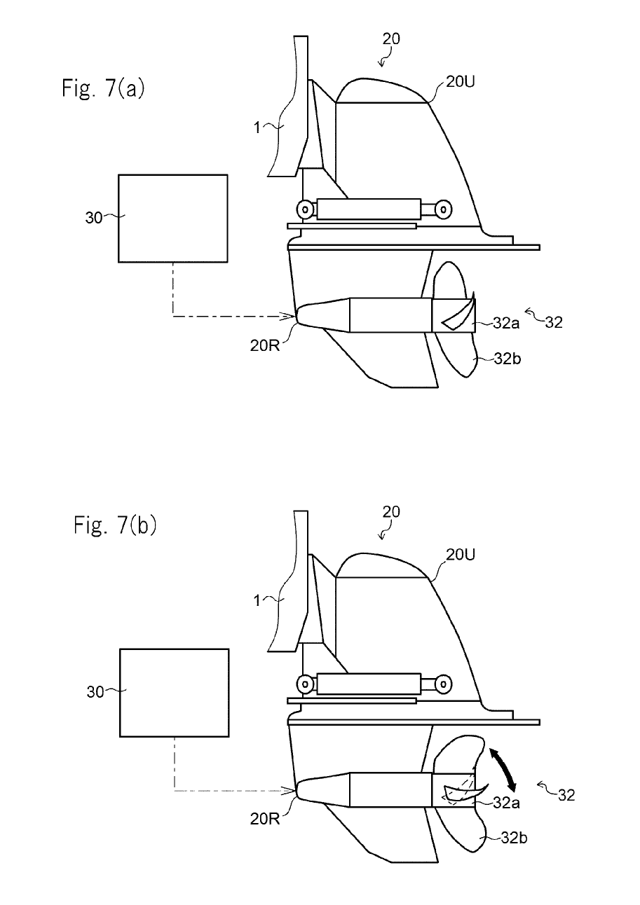

As shown in FIG. 7, a propeller 32 of the outdrive device 20 generates propulsion power by rotation. The propeller 32 is driven by the rotational power of the engine 10 transmitted via the output shaft 24 and the like, and a plurality of blades 32b arranged around a rotation shaft 32a paddle water so as to generate propulsion power. The propeller 32 is configured by a variable pitch propeller whose propeller pitch θ (attack angle). Then, by setting the propeller pitch θ to the maximum angle Amax (feathering), the propeller 32 minimize effect from water flow (see a black arrow in FIG. 7(b)).

The ship navigation control device 30 is connected to the outdrive device 20 and can control the propeller pitch θ of the propeller 32.

A control mode of pressure suppression of the fuel injection device 11 of the stopped engine 10 in the ship 100 which is the third embodiment of the ship according to the present invention is explained.

In the case in which some of the engines 10 are stopped, when the log speed V reaches the predetermined speed Vt, the ship navigation control device 30 shifts the propeller pitch θ of the propeller 32 of the stopped engine 10 to feathering state. When a start signal of the stopped engine 10 is received, the ship navigation control device 30 shifts the propeller pitch θ of the propeller 32 of the stopped engine 10 to normal state.

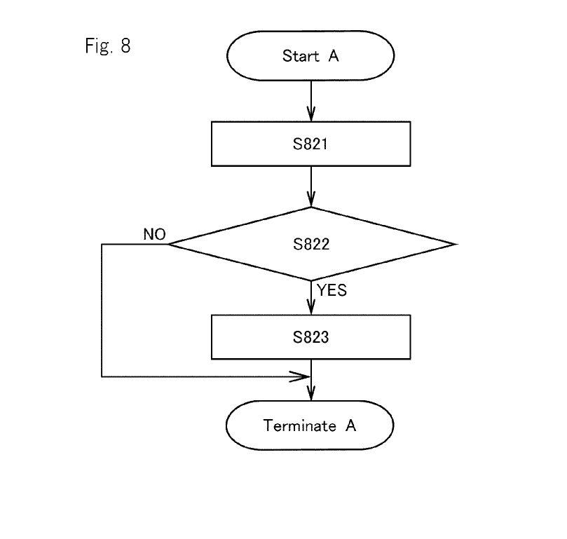

Next, the control mode of the ship navigation control device 30 is explained concretely referring to FIGS. 4 and 8.

As shown in FIG. 4, at the steps S100 to S700, the ship navigation control device 30 performs the control similar to the above control mode.

At the step S800, the ship navigation control device 30 starts the pressure suppression control A and shifts the control process to a step S821 (see FIG. 8). When the pressure suppression control A is terminated, the ship navigation control device 30 shifts the control process to the step S100.

As shown in FIG. 8, at the step S821 of the pressure suppression control A, the ship navigation control device 30 shifts the propeller pitch θ of the propeller 32 of the stopped engine 10 to the feathering state and shifts the control process to a step S822.

At the step S822, the ship navigation control device 30 judges whether a start signal of the stopped engine 10 is received or nor.

As a result, when the start signal of the stopped engine 10 is judged to be received, the ship navigation control device 30 shifts the control process to a step S823.

On the other hand, when the start signal of the stopped engine 10 is judged not to be received, the ship navigation control device 30 terminates the pressure suppression control A.

At the step S823, the ship navigation control device 30 shifts the propeller pitch θ of the propeller 32 of the stopped engine 10 to the normal state and terminates the pressure suppression control A.

According to the configuration, the ship navigation control device 30 shifts the propeller pitch θ of the propeller 32 to the feathering state so as to minimize resistance from the water flow, whereby generation of rotation power in the propeller 32 by the water flow is suppressed. Accordingly, increase of the pressure P of the common rail 13 of the fuel injection device 11 of the stopped engine 10 by rotation power of the water flow can be prevented beforehand.

### INDUSTRIAL APPLICABILITY

The present invention can be used for a ship having pressure suppression function of a fuel injection device.

### DESCRIPTION OF NOTATIONS

10 engine
10a output shaft
25 propeller
30 ship navigation control device
100 ship
V velocity of water flow with respect to ship (log speed)
Vt predetermined speed

1. A ship in which a plurality of engines are controlled by a ship navigation control device,
characterized in that
one or more propellers are connected interlockingly to the plurality of the engines, and
in the state in which one or more of the plurality of the engines are stopped, when a speed of water flow with respect to the ship is not less than a predetermined speed, the ship navigation control device judges that there is a possibility of an output shaft of the stopped engine being rotated by power applied from the water flow to the propeller.

2. The ship according to claim 1, wherein when the possibility of the output shaft of the stopped engine being rotated by the power applied from the water flow to the propeller is judged to exist, the ship navigation control device turns on a control device of the stopped engine.

3. The ship according to claim 2,
wherein in the engine, a fuel regulating valve is provided in a suction port of a fuel supply pump,
wherein the output shaft and the propeller are connected interlockingly via a clutch transmitting rotation power from the engine to the propeller, and
wherein when the possibility of the output shaft of the stopped engine being rotated by the power applied from the water flow to the propeller is judged to exist, the ship navigation control device closes the fuel regulating valve of the stopped engine and shifts the clutch to a neutral position.

4. The ship according to claim 2,
wherein in the engine, a pressure relief valve is provided in a fuel injection device, and
wherein when the possibility of the output shaft of the stopped engine being rotated by the power applied from the water flow to the propeller is judged to exist, the pressure relief valve of the stopped engine is opened.

5. The ship according to claim 1,
wherein a closing valve is provided in a fuel pipe, and
wherein in the state in which one or more of the plurality of the engines are stopped, when the speed of the water flow with respect to the ship is not less than the predetermined speed, the ship navigation control device judges that there is a possibility of the output shaft of the stopped engine being rotated by power applied from the water flow to the propeller and closes the closing valve.

6. The ship according to claim 3,
wherein in the engine, a pressure relief valve is provided in a fuel injection device, and
wherein when the possibility of the output shaft of the stopped engine being rotated by the power applied from the water flow to the propeller is judged to exist, the pressure relief valve of the stopped engine is opened.
